(19) United States
(12) Patent Application Publication
(10) Pub. No.: US 2024/0319043 A1
(43) Pub. Date: Sep. 26, 2024

(54) OUTPUT FROM ACOUSTIC INPUT

(71) Applicant: Ford Global Technologies, LLC, Dearborn, MI (US)

(72) Inventors: Huanyi Shui, Ann Arbor, MI (US); Rajesh Gupta, Auburn Hills, MI (US); Gurram Sujith Kumar, Sullurpeta (IN); Devesh Upadhyay, Canton, MI (US); Rajeev Kalamdani, Canton, MI (US); Douglas K. Grimes, Commerce Twp., MI (US); Saumuy Puchala, Ypsilanti, MI (US)

(73) Assignee: Ford Global Technologies, LLC, Dearborn, MI (US)

(21) Appl. No.: 18/187,077

(22) Filed: Mar. 21, 2023

(51) Int. Cl. G01M 13/028; G06N 20/00

(52) U.S. Cl. CPC G01M 13/028; G06N 20/00

(57) ABSTRACT

A system is disclosed that includes a computer and memory, the memory including instructions to transform acoustic data to an order spectrum and input the order spectrum to a decoder to determine a feature vector. The feature vector can be input to a one-class classifier to classify the order spectrum as anomalous or non-anomalous and the classified order spectrum can be output.

### BACKGROUND

Various machines, such as vehicles, and emit sounds during operation, including at frequencies audible to humans. Sounds can be captured and stored, and then used in different ways to evaluate a vehicle's noise, vibration, harshness (NVH), sound quality characteristics, and drive enhancements to the vehicle system.

### BRIEF DESCRIPTION OF THE DRAWINGS

FIG. 1 is a block diagram of an example vehicle system.

FIG. 2 is a diagram of an example vehicle including a microphone.

FIG. 3 is a diagram of an example graph of acoustic data.

FIG. 4 is a diagram of an example graph of an order spectrum.

FIG. 5 is a diagram of another example graph of an order spectrum.

FIG. 6 is a diagram of an example order spectrum analysis training system.

FIG. 7 is a diagram of an example order spectrum analysis system.

FIG. 8 is a flowchart diagram of an example process to train and deploy an order spectrum analysis system.

### DETAILED DESCRIPTION

Acoustic data detected during operation of a machine can be used in a variety of ways. In one non-limiting example, acoustic data can be used for analysis of noise, vibration, and harshness (NVH), e.g., in vehicle transmission manufacturing. Noise in the context of NVH is acoustic energy typically occurring in the frequency range from 30 to 4000 Hz. Vibration is transmitted through physical motion of machine, e.g., vehicle, parts and is typically in the frequency range from 30 to 200 Hz. Harshness includes abrupt changes in sound levels. Harshness can be quantified by determining when a first derivative of the graphed acoustic energy exceeded a user-defined threshold, for example. Vehicle transmissions are examples of machine components that are complex devices including hundreds or thousands of parts requiring precision manufacturing and assembly. Determining that a newly manufactured machine or set of machine components such as a vehicle transmission is operating up NVH standards set by the manufacturer can be performed by analyzing acoustic data acquired from the operating vehicle transmission.

NVH analysis as applied to vehicle transmissions includes more than a simple measure of acoustic energy, e. g., loudness. To determine whether a vehicle transmission has been manufactured within manufacturer's NVH standards, acoustic data is typically acquired while a vehicle transmission is operating over a range of speeds. The acoustic data can be analyzed to determine loudness and patterns at a range of frequencies. Analysis of acoustic data for machines that include rotating parts, such as transmissions, can be enhanced by transforming the acoustic data into an order spectrum. An order spectrum graphs the magnitude of acoustic energy versus rotational speed. Acoustic data is typically recorded as digital time series data, where the acoustic data is sampled at a rate that can be two and one half times greater than the highest frequency to be analyzed. An order spectrum requires that the rotation speed of one or more parts of the transmission be recorded along with the acoustic data. The acoustic data can be replotted as a function of rotation speed. Plotting acoustic data in an order spectrum as a function of rotation speed can permit noise and vibrations that occur at specific rotation speeds to be identified.

Another type of order spectrum generation, called order tracking, uses Vold-Kalman filtering to perform simultaneous estimation of multiple orders, e.g., separating orders from two or more transmission shafts that may be rotating as different speeds. Order tracking can permit systems subject to radical revolution per minute (RPM) changes, such as transmissions, to be tracked also through the transient events (e.g., gear shifts) associated with abrupt changes in inertia and boundary conditions. Order tracking extracts selected orders (RPMs) from acoustic data in terms of amplitude and phase. The order functions are extracted without time delay (no phase shift) and can be used for removal of nuisance orders (noise). In Vold-Kalman filtering, acoustic data at an order (RPM) of interest, is frequency shifted to DC based on the instantaneous RPM and then lowpass filtered which replaces the bandpass filtering process of typical order spectrum generation. As a result, Vold-Kalman filtration includes simultaneous envelope detection of both magnitude and phase of the acoustic data at a given RPM.

Analysis of order spectrum data, whether raw amplitude or frequency components, can be accomplished by acquiring baseline acoustic data from known good vehicle transmissions (e.g., transmissions that operate correctly and within NVH standards). Vehicle transmissions can be either known to be good or faulty (e.g., transmissions that do not operate correctly and/or within NVH standards are faulty). Whether a transmission is known to be good or faulty can be determined by comparing order spectrum data from a unit under test to baseline acoustic data to determine whether the newly acquired order spectrum data includes an anomaly. An anomaly is a difference between a newly acquired order spectrum and a baseline order spectrum that indicates that the unit under test does not meet NVH standards for vehicle transmissions as determined by subject matter experts inspecting a plurality of order spectra. A subject matter expert is a person, such as a quality control engineer, experienced in determining whether or not a device such as a transmission is operating properly.

Techniques described herein enhance detection of anomalies in order spectrum data by training a neural network based on order spectrum data from known good vehicle transmissions. Known good transmissions are transmissions that have been determined to operate correctly and within established NVH standards. Ground truth for training the neural network is determined by subjecting transmissions to order spectrum analysis by subject matter experts. The subject matter experts can determine points in the order spectrum data that include anomalies that distinguish good transmissions from faulty transmissions. Newly acquired order spectrum data is input to the trained neural network to determine whether the newly acquired order spectrum includes anomalies that cause it to deviate from baseline order spectra. Detection of anomalies in order spectrum data by a neural network enhances order spectrum analysis by reducing time required to determine anomalies and mitigating possible differences between individuals in determining anomalies. Detection of anomalies in order spectrum data by neural networks as described herein can detect more anomalies more accurately by processing more order spectrum data at higher resolutions than typically otherwise possible.

Disclosed herein is a method, including transforming acoustic data to an order spectrum. The order spectrum can be input to a decoder to determine a feature vector, the feature vector can be input to a one-class classifier to classify the order spectrum as anomalous or non-anomalous, and the classified order spectrum can be output. The acoustic data can be determined by acquiring sound from a device that includes rotating components. An anomalous order spectrum can indicate a fault in the device. The device can be a vehicle transmission. The order spectrum can be classified as anomalous by determining a portion of the classified order spectrum that occurs outside of learned boundaries. The decoder can be trained to determine the learned boundaries by training a decoder to classify the feature vector using non-anomalous data.

The decoder can be trained using an encoder to encode the feature vector into a second order spectrum. A plurality of decoders can be trained to determine a plurality of anomalies. The one-class classifier can be a support vector machine. The classified order spectrum can be validated by comparing the classified order spectrum to results of vehicle road testing. The decoder can be a neural network. The neural network can be retrained based on validating the classified order spectrum. The acoustic data can be transformed into the order spectrum by performing a Vold-Kalman filter on the acoustic data. The Vold-Kalman filter can be used to perform simultaneous estimation of multiple orders.

Further disclosed is a computer readable medium, storing program instructions for executing some or all of the above method steps. Further disclosed is a computer programmed for executing some or all of the above method steps, including a computer apparatus, programmed to transform acoustic data to an order spectrum. The order spectrum can be input to a decoder to determine a feature vector, the feature vector can be input to a one-class classifier to classify the order spectrum as anomalous or non-anomalous, and the classified order spectrum can be output. The acoustic data can be determined by acquiring sound from a device that includes rotating components. An anomalous order spectrum can indicate a fault in the device. The device can be a vehicle transmission. The order spectrum can be classified as anomalous by determining a portion of the classified order spectrum that occurs outside of learned boundaries. The decoder can be trained to determine the learned boundaries by training a decoder to classify the feature vector using non-anomalous data.

The instructions can include further instructions to train the decoder using an encoder to encode the feature vector into a second order spectrum. A plurality of decoders can be trained to determine a plurality of anomalies. The one-class classifier can be a support vector machine. The classified order spectrum can be validated by comparing the classified order spectrum to results of vehicle road testing. The decoder can be a neural network. The neural network can be retrained based on validating the classified order spectrum. The acoustic data can be transformed into the order spectrum by performing a Vold-Kalman filter on the acoustic data. The Vold-Kalman filter can be used to perform simultaneous estimation of multiple orders.

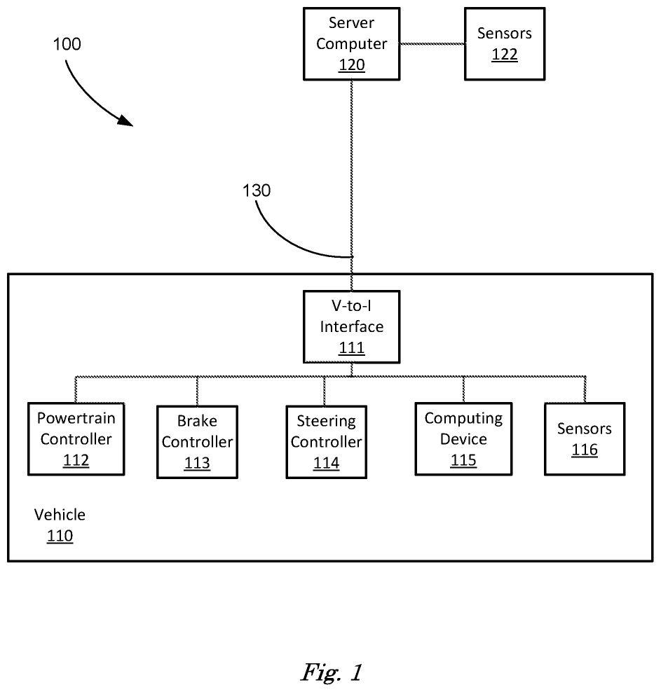

FIG. 1 is a diagram of a vehicle system 100 that can include a server computer 120 and sensors 122. One or more vehicle 110 computing devices 115 can receive data regarding the operation of the vehicle 110 from sensors 116. The computing device 115 may operate the vehicle 110 via propulsion, brakes, and/or steering. and/or components thereof, such as are known.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110.

The vehicle 110 is generally a land-based vehicle 110, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

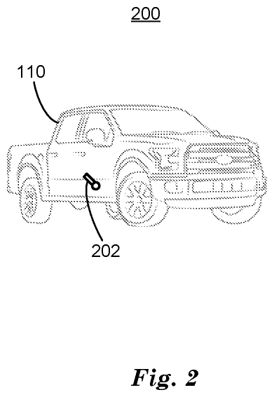

FIG. 2 is a diagram of an example vehicle 110 including a microphone 202. Data from microphone 202 can be sensor 122 connected to a server computer 120 or a sensor 116 connected to a computing device 115. Acoustic data output from a microphone 202 as a voltage can be converted to a digital signal by an analog-to-digital converter included in server computer 120 or computing device 115. Microphone 202 can be arranged to acquire acoustic data from a transmission included in a vehicle 110. The acoustic data can be analyzed using order spectrum techniques described herein to determine NVH problems with vehicle components such as a transmission. A transmission can be a propulsion component that transmits rotary power from an internal combustion engine and/or electric motor to vehicle wheels via further propulsion components such as drive shafts, differentials, and axels, etc. Transmissions can include multiple gears and/or other assemblies that can alter the ratio of input rotational speed to output rotational speed in response to commands from computing device 115 via propulsion controller 112. A transmission can include rotating parts that can be used to determine an order spectrum based on recorded acoustic data and data regarding the rotational speed of parts included in the transmission.

A technique for determining transmission NVH problems is to record acoustic data from the transmission while it is being operated. The acoustic data can be recorded while the vehicle 110 is being operated on a test stand, which permits the driven wheels (front or rear or both, depending upon the vehicle configuration) to rotate while the vehicle 110 is held motionless. A test stand permits a stationary microphone 202 to record acoustic data to a server computer 120 included in a manufacturing facility. Acoustic data can alternatively or additionally be recorded while the vehicle 110 is operated on a roadway by acquiring the acoustic data with an acoustic sensor 116 that provides data to a computing device 115 included in the vehicle 110. In either example, operating data including the time at which the acoustic data was acquired and the rotational speeds of transmission parts such as gears and shafts can be recorded and stored along with the temporal and acoustic data.

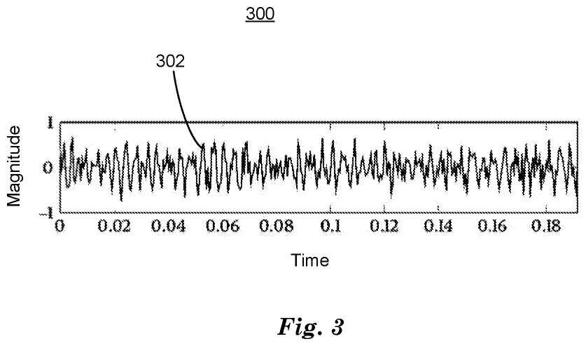

FIG. 3 is a diagram of an example time series graph 300 illustrating acoustic data 302. Graph 300 plots magnitude on the Y-axis, where magnitude indicates the voltage of the input acoustic data and time on the X-axis. The acoustic data 302 in time series graph 300 is an AC-coupled signal, meaning that the voltage varies from −1.0 volts to 1.0 volts, averaging about 0 volts. The acoustic data varies with time as the transmission under test is cycled through different speeds and gears. This variation of acoustic data makes it difficult to determine possible patterns indicating NVH problems of the transmission.

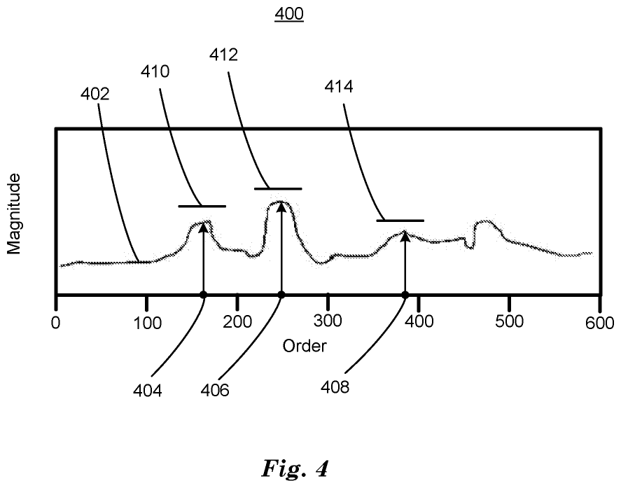

FIG. 4 is a diagram of an example order spectrum graph 400 illustrating acoustic data acquired from a transmission under test that has been transformed into an order spectrum 402. An order spectrum graph 400 plots a magnitude of acoustic energy, which can be measured in decibels, against the rotational speed of a selected part of the transmission under test. Voltages in time series graph 300 can be converted into decibels by calibrating the microphone 202 and computing device 115 using a calibrated sound pressure meter that measures sound pressure levels according to the American National Standard on Acoustic Terminology standard ANSI/ASA S1.1-2013. An order spectrum graph 400 plots a magnitude of the order spectrum 402 on the Y-axis vs. an order on the X-axis that indicates the rotational speed of the transmission in revolutions per minute (RPM). The magnitude in this example is the power of the acoustic signal determined as a square root of an average squared (root-mean-square or RMS) value of the input acoustic data.

Plotting acoustic data as an order spectrum 402 illustrates acoustic data that occurs at specific rotational speeds of a rotating part of a transmission. Peaks, indicated by arrows in FIG. 4, occur that indicate acoustic energies or noises that occur in this example at specific rotational speeds 404, 406, 408. By analyzing a plurality of transmissions that includes transmission that are operating properly and transmissions that include NVH problems, thresholds 410, 412, 414 can be determined that indicate the maximum acoustic energy or noise generated at specific rotational speeds 404, 406, 408 for properly operating, i.e., non-faulty, transmissions. This analysis can be performed by a subject matter expert by inspection of the plurality of order spectrum 402 plots.

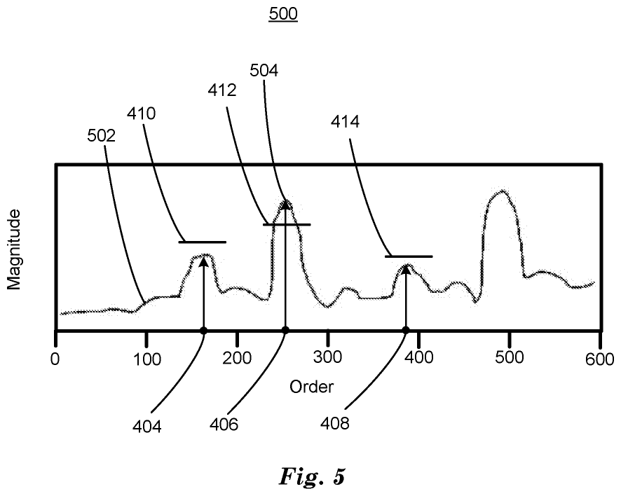

FIG. 5 is a diagram of an example order spectrum graph 500 illustrating acoustic data acquired from a transmission under test that has been transformed into an order spectrum 502. In this example, the second transmission includes a NVH problem. Arrows on the order spectrum graph 500 indicate the acoustic energies or noises that occur at the same rotational speeds 404, 406, 408 as indicated in FIG. 4. Comparing the order spectrum 502 indicated by the arrows at rotational speeds 404, 406, 408 with thresholds 410, 412, 414, it can be seen that the order spectrum data at rotational speed 406 exceeds the threshold 412, indicating an anomaly 504. The anomaly 504 indicated by the acoustic energy at rotational speed 406 exceeding threshold 412 can indicate a fault in the transmission.

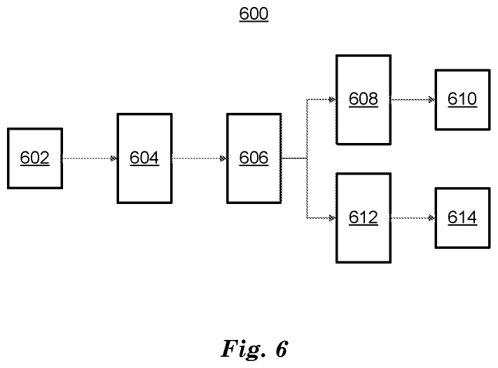

FIG. 6 is a diagram of an example order spectrum analysis training system 600. The order spectrum analysis training system 600 trains an order spectrum analysis system to input order spectrum data 602 and classify the order spectrum data 602 as anomalous or non-anomalous. Anomalous order spectrum data 602 is order spectrum data 602 that includes one or more anomalies 504. The order spectrum data 602 is generated by acquiring acoustic data from known good vehicle transmissions, e.g., vehicle transmissions that have been inspected by subject matter experts and indicate a transmission that will likely not be faulty.

The order spectrum analysis training system 600 begins by inputting the order spectrum 602 to an encoder 604. Encoder 604 is a neural network that includes a plurality of layers that each include neurons. Each neuron is capable of calculating one or more linear and/or non-linear functions on inputs and passing the result onto neurons in the next layer. The linear and/or non-linear functions and the connections to the neurons in a subsequent layer are determined by weights. Encoder 604 inputs order spectrum 602 data and processes it using the neurons included in the layers to output a feature vector 606.

The encoder 604 outputs a feature vector 606 which is a lower-dimensional representation of the input order spectrum data 602, e. g., the feature vector 606 has a lower L2 Norm. An example of an L2 Norm is the Euclidian distance from an origin. A lower-dimensional representation requires fewer bits to represent the input order spectrum data 602 without losing any data that indicates that the input order spectrum data 602 includes one or more anomalies 504. During training, the order spectrum data analysis training system 600 determines that the feature vector 606 has retained relevant data from the input order spectrum data 602 by inputting the feature vector 606 into a decoder 608. The decoder 608 is a neural network similar to encoder 604 that is trained to input a feature vector 606 and outputs reconstructed order spectrum data 610. At training time, a loss function can be determined by comparing the reconstructed order spectrum data 610 to the input order spectrum data 602 to determine whether the feature vector 606 includes all of the relevant data from the input order spectrum data 602 while reducing the L2 Norm including anomalies.

Training the encoder 604 includes determining a loss function based on comparing output reconstructed order spectrum data 610 and output classification results 614 to input ground truth, which is this example is the input order spectrum data 602 which has been classified as non-anomalous. An order spectrum that has been classified as non-anomalous is an order spectrum that does not include any anomalies 504. The loss function can be back propagated through the layers of encoder 604 to determine an optimal set of weights that provides a minimal loss function based on the training dataset of order spectrum data 602. Back propagation is a technique for distributing the loss function from layers of the encoder 604 closest to the output, through the layers of the encoder 604 to the input layer of encoder 604.

Non-anomalous order spectrum data 610 is used to train an order spectrum analysis system to permit a one-class classifier to classify the feature vector. Including anomalies 504 in the training data would introduce two or more classes into the output classification results 614, which would require the use of a higher-dimension classifier. Following initial training with non-anomalous data, order spectrum data 610 that includes an anomaly can be introduced to determine that the one-class classifier can detect a portion of the feature vector that falls outside of the learned boundaries established by the support vector machine and correctly classify them as anomalous. In some examples, an order spectrum analysis training system 600 can train a plurality of decoders 604 and a plurality of one-class classifiers 612 to detect a plurality of different anomalies 504.

The order spectrum data analysis training system 600 inputs the feature vector 606 to a one-class classifier 612. The one-class classifier 612 determines a minimal enclosing boundary that encloses the classification results 614 output from one-class classifier 612. The minimal enclosing boundary is determined in a multi-dimensional hyperspace with the same number of dimensions as a feature vector 606. Because the input order spectrum data 602 includes only known good order spectrum data, all of the feature vectors 606 should map into a cluster in hyperspace that indicates known good input order spectrum data 602. An example technique for determining clusters in hyperspace is a support vector machine. A support vector machine determines a plurality of hyperplanes in hyperspace that enclose the cluster of feature vectors 606 in a minimal volume. A loss function for training the one-class classifier 612 can be determined by determining a volume of the enclosed cluster of classification results 614.

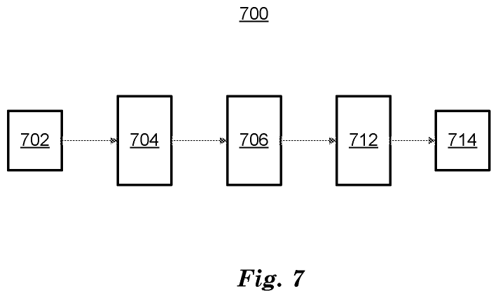

FIG. 7 is a diagram of a trained order spectrum analysis system 700. Order spectrum analysis system 700 inputs order spectrum data 702 from vehicle transmissions as the vehicle is completed in a manufacturing facility. The order spectrum data 702 in input to a trained encoder 704, trained as discussed above in relation to FIG. 6. The trained encoder 704 outputs a feature vector 706 which is input to a trained one-class classifier 712. The one-class classifier 712 classifies the feature vector 706 to determine its classification results 714. The classification results 714 are compared to the cluster in hyperspace determined for the known good order spectrum data 602 from FIG. 6. If the classification results 714 are located outside of the boundaries of the minimal cluster determined for the known good spectrum data 602, the order spectrum data 702 includes one or more anomalies 504 that indicate a faulty transmission. The vehicle 110 that includes the faulty transmission can be diverted to a repair facility.

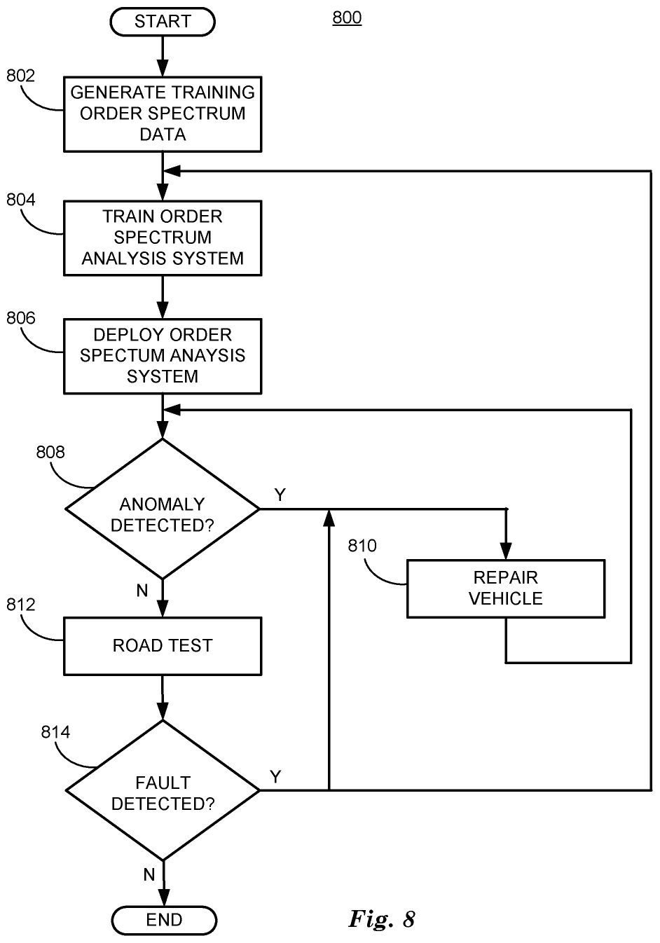

FIG. 8 is a flowchart, described in relation to FIGS. 1-7 of a process 800 for training and deploying an order spectrum analysis system 700. Process 800 can be implemented by a processor of a server computer 120, taking as input acoustic data acquired by a microphone 202, executing commands, and outputting classification results 714. Process 800 includes multiple blocks that can be executed in the illustrated order. Process 800 could alternatively or additionally include fewer blocks or can include the blocks executed in different orders.

Process 800 begins at block 802, where a server computer 120 generates order spectrum data 602 and ground truth data for training an order spectrum analysis system 700 as discussed above in relation to FIG. 6. The order spectrum data 602 is generated by recording acoustic data 302 using microphones 202 and transforming the acoustic data 302 into order spectrum data 602 using rotational data recorded along with the time series acoustic data 302. The ground truth data includes determining that the order spectrum data 602 does not include anomalies that indicate possible faults.

At block 804 the server computer 120 trains the order spectrum analysis system 700 using the order spectrum analysis training system 600 as discussed above in relation to FIG. 6.

At block 806 the server computer 120 deploys the order spectrum analysis system 700. Deploying the order spectrum analysis system 700 includes transmitting the order spectrum analysis system 700 to one or more cloud-based server computers 120 where the spectrum analysis system 700 can be accessed by client computing devices that include microphones 202 at various locations.

At block 808 deployed order spectrum analysis systems 700 acquire order spectrum data 702 from vehicle transmissions under test and determine whether output classification results 714 indicate a fault based on detecting anomalies in the order spectrum data 702. If no anomalies indicating a transmission fault are detected, process 800 branches to block 812. If an anomaly is detected that indicates a transmission fault, process 800 branches to block 810.

At block 810 the deployed order spectrum analysis system 700 has detected an anomaly in the input order spectrum data 702 and directs the vehicle 110 that includes the faulty transmission to a repair facility to determine the source of the anomaly and repair it. Following the repair to the vehicle is returned to block 808 to acquire and analyze order spectrum data 702 using the deployed order spectrum analysis system 700 to determine that the repair has successfully eliminated the anomaly from the order spectrum data 702.

At block 812 a vehicle 110 that has passed the order spectrum analysis system by not having a detected anomaly or has been successfully repaired following a detected anomaly is optionally vehicle road tested. Road testing includes driving the vehicle to determine proper operation of the vehicle transmission.

At block 814 the results of the road test are evaluated. If one or more faults are detected by road testing the transmission, the vehicle is returned to block 810 for repair. In addition, order spectrum data 702 is acquired following the optional road test performed at block 812 and returned to block 804 to validate the order spectrum analysis system 700. The order spectrum analysis system 700 can be validated by processing the returned order spectrum data 702 to confirm that order spectrum analysis system 700 detects anomalies that result in faults detected by road testing. In some examples road testing can detect transmission faults that might not have been detected by the deployed order spectrum analysis system 700. In examples where faults occur without order spectrum analysis system 700 detecting anomalies, the order spectrum analysis system 700 can be retrained based on the returned order spectrum data 702 and re-deployed. If no transmission fault is detected, following block 814 process 800 ends.

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
transform acoustic data to an order spectrum;
input the order spectrum to a decoder to determine a feature vector
input the feature vector to a one-class classifier to classify the order spectrum as anomalous or non-anomalous; and
output the classified order spectrum.

2. The system of claim 1, wherein the acoustic data is determined by acquiring sound from a device that includes rotating components.

3. The system of claim 2, wherein an anomalous order spectrum indicates a fault in the device.

4. The system of claim 3, wherein the device is a vehicle transmission.

5. The system of claim 1, the instructions including further instructions to classify the order spectrum as anomalous by determining a portion of the classified order spectrum that occurs outside of learned boundaries.

6. The system of claim 5, the instructions including further instructions to train the decoder to determine the learned boundaries by training the one-class classifier to classify the feature vector using non-anomalous data.

7. The system of claim 1, the instruction including further instructions to train the decoder using an encoder to encode the feature vector into a second order spectrum.

8. The system of claim 1, wherein a plurality of decoders are trained to determine a plurality of anomalies.

9. The system of claim 1, wherein the one-class classifier is a support vector machine.

10. The system of claim 1, wherein the classified order spectrum is validated by comparing the classified order spectrum to results of vehicle road testing.

11. The system of claim 1, wherein the decoder is a neural network.

12. The system of claim 11, wherein the neural network is retrained based on validating the classified order spectrum.

13. The system of claim 1, wherein the acoustic data is transformed into the order spectrum by performing a Vold-Kalman filter on the acoustic data.

14. A method, comprising:
transforming acoustic data to an order spectrum;
inputting the order spectrum to a decoder to determine a feature vector
inputting the feature vector to a one-class classifier to classify the order spectrum as anomalous or non-anomalous; and
outputting the classified order spectrum.

15. The method of claim 14, wherein the acoustic data is determined by acquiring sound from a device that includes rotating components.

16. The method of claim 15, wherein an anomalous order spectrum indicates a fault in the device.

17. The method of claim 16, wherein the device is a vehicle transmission.

18. The method of claim 14, further comprising classifying the order spectrum as anomalous by determining a portion of the classified order spectrum that occurs outside of learned boundaries.

19. The method of claim 18, further comprising training the decoder to determine the learned boundaries by training a decoder to classify the feature vector using non-anomalous data.

20. The method of claim 14, further comprising training the decoder using an encoder to encode the feature vector into a second order spectrum.
